(19) United States
(12) Patent Application Publication
(10) Pub. No.: US 2026/0127035 A1
(43) Pub. Date: May 7, 2026

(54) TARGETED ACCELERATOR DISPATCH

(71) Applicant: INTERNATIONAL BUSINESS MACHINES CORPORATION, Armonk, NY (US)

(72) Inventors: Cedric LICHTENAU, Stuttgart (DE); Simon FRIEDMANN, Boeblingen (DE); Simon BUBECK, Baden-Wuerttemberg (DE); Craig R. WALTERS, Highland, NY (US)

(21) Appl. No.: 18/934,481

(22) Filed: Nov. 1, 2024

(51) Int. Cl. G06F 9/50

(52) U.S. Cl. CPC G06F 9/5044; G06F 9/505

(57) ABSTRACT

Computer implemented methods, systems, and computer program products include program code executing on a processor(s) which initiate, from a first chip in a computing system, a request to utilize an accelerator in the computing system to process work associated with a given workload. The program code determines that a local accelerator on the first chip is not available to accept a dispatch of the work. The program code obtains hardware monitoring data from local hardware counters associated with various elements of the computing system. The program code determines, based on the hardware monitoring data, a best remote accelerator for dispatching the work to by selecting an accelerator that utilizes bandwidth and one or more caches which are minimally accessed by other workloads processing in the computing system concurrently with the given workload when compared the other accelerators comprising the one or more remote accelerators.

### BACKGROUND

One or more aspects relate, in general, to facilitating processing within a computing environment, and in particular, to protect workloads running in parallel with workloads requesting to utilize a particular accelerator.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Performance accelerators, also known as accelerators (including hardware accelerators) are microprocessors or specialized circuits or functions that are capable of accelerating certain workloads. Workloads that can be accelerated are offloaded to the performance accelerators, which are much more efficient at performing workloads, such as AI, machine vision, and deep learning. Performance acceleration can integrate general-purpose processors and more specific purpose processors to work together simultaneously to perform a task. Performance accelerators are capable of performing parallel computations rather than serial computing.

### SUMMARY

Shortcomings of the prior art are overcome, and additional advantages are provided through the provision of a computer-implemented method for performance sensitive targeted accelerator dispatch. The method can include: initiating, by one or more processors from a first chip in a computing system, a request to utilize an accelerator in the computing system to process work associated with a given workload; determining, by the one or more processors, that a local accelerator on the first chip is not available to accept a dispatch of the work; obtaining, by the one or more processors, hardware monitoring data from local hardware counters associated with various elements of the computing system; and determining, based on the hardware monitoring data, a best remote accelerator for dispatching the work to, wherein the best remote accelerator comprises selecting an accelerator from one or more remote accelerators in the computing system, wherein based on the hardware monitoring data the selected accelerator utilizes bandwidth and one or more caches which are minimally accessed by other workloads processing in the computing system concurrently with the given workload when compared the other accelerators comprising the one or more remote accelerators.

Shortcomings of the prior art are overcome, and additional advantages are provided through the provision of a computer program product for performance sensitive targeted accelerator dispatch. The computer program product comprises a storage medium readable by one or more processors and storing instructions for execution by the one or more processors for performing a method. The method includes, for instance: initiating, by the one or more processors from a first chip in a computing system, a request to utilize an accelerator in the computing system to process work associated with a given workload; determining, by the one or more processors, that a local accelerator on the first chip is not available to accept a dispatch of the work; obtaining, by the one or more processors, hardware monitoring data from local hardware counters associated with various elements of the computing system; and determining, based on the hardware monitoring data, a best remote accelerator for dispatching the work to, wherein the best remote accelerator comprises selecting an accelerator from one or more remote accelerators in the computing system, wherein based on the hardware monitoring data the selected accelerator utilizes bandwidth and one or more caches which are minimally accessed by other workloads processing in the computing system concurrently with the given workload when compared the other accelerators comprising the one or more remote accelerators.

Shortcomings of the prior art are overcome, and additional advantages are provided through the provision of a system for performance sensitive targeted accelerator dispatch. The system includes: a memory, one or more processors in communication with the memory, and program instructions executable by the one or more processors via the memory to perform a method. The method can include initiating, by the one or more processors from a first chip in a computing system, a request to utilize an accelerator in the computing system to process work associated with a given workload; determining, by the one or more processors, that a local accelerator on the first chip is not available to accept a dispatch of the work; obtaining, by the one or more processors, hardware monitoring data from local hardware counters associated with various elements of the computing system; and determining, based on the hardware monitoring data, a best remote accelerator for dispatching the work to, wherein the best remote accelerator comprises selecting an accelerator from one or more remote accelerators in the computing system, wherein based on the hardware monitoring data the selected accelerator utilizes bandwidth and one or more caches which are minimally accessed by other workloads processing in the computing system concurrently with the given workload when compared the other accelerators comprising the one or more remote accelerators.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is an illustration of a technical architecture where various aspects of the present disclosure can be implemented;

FIG. 3 is a workflow that illustrates various aspects of a targeted accelerator dispatch based on real-time hardware activity provided in the present disclosure;

FIG. 4 is an illustration of a technical architecture where various aspects of the present disclosure can be implemented; and

FIG. 5 is a workflow that illustrates various aspects of a targeted accelerator dispatch based on real-time hardware activity provided in the present disclosure.

### DETAILED DESCRIPTION

The computer-implemented methods, computer program products, and systems described herein comprise program code executing on one or more processors that maximizes or optimized utilization of AI processing resources in a computing system (including in a shared or distributed computing system such as a cloud computing environment) while protecting performance and service level agreements (SLAs) related to other workloads, including but not limited to, other sensitive workloads. Although certain of the examples herein are described as controlling accelerator deployment and usage as related to balancing AI processing with other types of workloads, the examples herein can be utilized even in the absence of AI processing to balance and optimize processing operations, utilizing a variety of different types of accelerators, including but not limited to those located at a core (e.g. matrix-multiplication engine), on-chip accelerators, and/or accelerators on other chips in the system. In general, the computer-implemented methods, computer program products, and systems described herein can be executed on a computer system that comprises at least one accelerator and upon which one or more processors execute multiple applications.

As noted above, accelerators are capable of performing parallel computations rather than serial computing. This parallel computation aspect can lead to significantly more resource consumptions like memory bandwidth, memory caches or heat dissipation. These side effects can seriously impact the performance of other workloads running on the same machine and hence cause an overall degradation to workload with required latency or throughput execution and/or negatively impact the overall performance of all workloads running simultaneously on the machine. The examples herein control dispatches of work to accelerators while regarding the parallel workloads and not negatively impacting the processing of these workloads in order to preserve performance of the computing system as a whole.

The examples herein include computer-implemented methods, computer program products, and systems for performance sensitive targeted accelerator dispatch based on real-time hardware activity. In the examples, herein, program code executing on one or more processors controls hardware monitors to obtain results in real-time. The program code utilizes the results of the hardware monitors (continuously) to control, for example, accelerator dispatch, including the rate of dispatch. Various uses of the hardware monitors by the program code are described in more detail herein. In some examples, the program code ranks accelerators based on accelerator-unrelated activity on the chip containing the accelerator. The program code can control the dispatch and use of accelerators, for example, by determining that an accelerator should not be utilized if accelerator-unrelated activity too high on a chip containing the accelerator as well as activity related to links to the chip. In some examples, the program code can assess impacts of the use of an accelerator for a given task or process on other workloads and can protect these workloads. The program code can utilize a feedback loop to adapt the dispatch rate and/or a throttling to real-time hardware activity to changed monitored by the program code.

The examples herein, which include computer-implemented methods, computer program products, and systems for performance sensitive targeted accelerator dispatch based on real-time hardware activity, can be executed on a computing system that include at least one accelerator and runs multiple parallel time sensitive workloads. In some examples, program code executing on one or more processors of the computing systems collects system wide non-accelerator related real-time hardware monitor data. The data can include, but are not limited to, cache eviction activity for each cache hierarchy level, bandwidth utilization between chip and to memory, and/or a processor cache footprint of each workload running in the system. Based on the data, the program code can rank accelerators in the system based on accelerator-unrelated activity on each core/chip containing each accelerator. The program code can also consider link activity to reach each accelerator from initiator chip (e.g., the chip that initiated a request for an accelerator). In generating this ranking, the program code can also consider potential cross-workload interference and impacts to individual workload performance. In some examples, if the program code determines that accelerator-unrelated activity is below a certain threshold for a given accelerator, the program code dispatched work to that accelerator.

As the utility of AI increases, its processing demands in computing systems also increase. Additionally, many integrations of AI into computing systems are enterprise level integrations, which can exceed the capacity of a single processing unit or chip. Thus, there exists a need to efficiently execute AI operations within computing systems without compromising the performance, efficiency, utility, etc. of non-AI operations. Certain existing approaches address this issue by distributing AI processes over all AI-capable resources in a computing system. Unfortunately, this approach, while advantageous to AI processing, can significantly hinder other workloads running on the same system. Distributing AI processing in this manner can utilize all the memory bandwidth or cache resources in a system, negatively impacting other workloads. As a non-limiting example, certain existing AI processing distribution approaches have been found to have impacts on existing workloads that hinder their processing by more than thirty percent. This is just one isolated example, but the impacts of this type of distribution are not system neutral. The performance of distributed (e.g., enterprise, shared, cloud, etc.) computing systems is governed by SLAs and a failure to meet the SLAs or other performance requirements adversely affects the utility of the computing systems. The examples described herein, unlike this equal distribution approach, consider the performance of transactions and tasks end to end rather than just the AI portion of the execution to optimize AI processing while not compromising other workloads (e.g., so as not have a negative impact on missed SLA and business opportunities).

The computer-implemented methods, computer program products, and systems described herein provide significantly more than existing approaches to meeting AI processing requirements within computing systems. The existing approaches focus on the top-level systems management side, as opposed to examples herein, which utilize co-optimization and proactive balancing various workloads (AI and non-AI) to meet processing goals, including, for example, to ensure SLA compliance. The examples herein provide significantly more by implementing a method that monitors the utilization of system resources to proactively control at least one accelerator to enable efficient processing of AI and non-AI workloads, by performing activities, including but not limited to throttling accelerator usage, dispatching characteristics for utilizing accelerators, and/or adjusting system performance based on defined anticipated impact ranges. Although certain existing approaches include algorithms that provide pre-resource allocation of accelerators, rather than provide pre-resource allocation, the program code in the examples herein implement a dynamic usage of available accelerator resources while controlling the impact of this dynamic usage on other workloads.

The examples herein are inextricably tied to computing at least because they implement hardware and software elements to optimize processing in computing systems where the computing systems include resources that execute both AI and non-AI workloads. The examples herein are directed to the practical application of optimizing processing in a distributed computing system executing a diversity of software processes (and/or services), including performing AI processing, and/or enabling the system to operate within established standards while effectively processing AI workloads. The examples herein are inextricably tied to computing at least because in addressing this practical application, which is an issue exclusive to computing in a distributed architecture, the examples herein utilize both hardware and software elements of a computing infrastructure. For example, program code executing on one or more processors in the examples herein utilizes system wide hardware counters and chip-to-chip links and memory interfaces to determine cache activity and/or cache utilization, chip-to-chip links and memory interfaces. The program code in these examples can throttle and/or alter access (dispatch) of work to accelerators and/or control the performance of the accelerators to balance system resource or reach and define performance target for the various workloads. In some examples, the monitoring by the hardware and software mechanisms can be utilized to monitor impacts on other workloads and the program code can throttle and/or steer accelerator(s) usage based on these impacts (e.g., reactively). Hence, in the examples herein, program code can not only load balance AI workloads to accelerators, but program code can also consider (and act upon) impacts to other workloads. The examples herein differ from general workload schedulers which try to distribute work across available resources, potentially reactively responding to over-commit issues using high level machine statistics, by instead proactively limiting or altering the dispatch of work to or performance of an accelerator to achieve top level performance goals.

The examples herein include a computer-implemented method for performance sensitive targeted accelerator dispatch. The method can include program code executing on one or more processors initiating, from a first chip in a computing system, a request to utilize an accelerator in the computing system to process work associated with a given workload. The program code determines that a local accelerator on the first chip is not available to accept a dispatch of the work. The program code obtains hardware monitoring data from local hardware counters associated with various elements of the computing system. The program code determined, based on the hardware monitoring data, a best remote accelerator for dispatching the work to. The best remote accelerator comprises selecting an accelerator from one or more remote accelerators in the computing system, where based on the hardware monitoring data the selected accelerator utilizes bandwidth and one or more caches which are minimally accessed by other workloads processing in the computing system concurrently with the given workload when compared the other accelerators comprising the one or more remote accelerators. This example is inextricably tied to computing and provides a benefit to a computing system at least because it utilizes a combination of hardware and software to distribute processing to available accelerators in an optimal manner.

In some examples, the program code determines if activity on a chip or core associated with best remote accelerator is below a pre-defined threshold. This example provides a benefit to the computing system because in existing approaches, processes, including AI processes, as distributed to accelerators capable of processing these types of processes without regard for the utilization of these resources by other processes being executed within the system. Thus, this aspect aids to ensure processing efficiencies throughout a computing system.

In some examples, the program code, based on determining that the activity on the chip or the core associated with best remote accelerator is below the pre-defined threshold, dispatches the work to the best remote accelerator. Implementing this aspect improves the computing system at least because it enables the selection of a capable accelerator but also guards the processing efficiencies throughout the computing system as a whole.

In some examples, the program code, based on determining that the activity on the chip or the core associated with best remote accelerator is not below the pre-defined threshold, queues the work for dispatch to the local accelerator. As aforementioned, the examples herein not only locate an accelerator for use for a given process, they examples also maintain the efficiencies throughout the system and in some situations, this translates to not dispatching work to a remote accelerator but rather, to wait until a local resource is available. This aspect benefits the system as a while because it balances the timing to improve a single process against the impacts to the computing system as a whole.

In some examples, the program code determines that the local accelerator is available and dispatches the work to the local accelerator. This aspect provides a benefit because it balances the timing to improve a single process against the impacts to the computing system as a whole.

In some examples, program code determining the best remote accelerator for dispatching the work to comprises program code ranking the one or more remote accelerators based on the hardware monitoring data. This aspect provides a benefit to computing systems into which it is implemented at least because the program code determines a best approach to dispatching a process to an accelerator and that the utility of the accelerator is not the only factor as a given accelerator that could handle work may not be a best accelerator to dispatch the work to because dispatching in this manner could adversely impact other work being accomplished by the computing system. Creating a ranking of accelerators accounts for the impacts and generates different levels of choices with a full understanding of overall computing system functionality and utility.

In some examples, program code ranking comprises ranking the one or more remote accelerators by cache usage. This aspect improves the functionality of the computing system at least because it acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples, program code ranking comprises ranking the one or more remote accelerators based on accelerator-unrelated activity on each chip or core comprising each remote accelerator of the one or more accelerators. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples, program code ranking comprises evaluating link activity to reach each remote accelerator of the one or more remote accelerators from the first chip. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples, the program code ranking comprises the program code evaluating potential cross-workload interference and impact to individual workload performance for workloads running on the computing system. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples, the program code determines the cache usage of the one or more remote accelerators independent of accelerator availability. This aspect improves the functionality of the computing system and provides an advantage over existing approaches because in determining whether to dispatch a process to an accelerator, the program code is cognizant of other work being processed by the system as a whole, therefore optimizing a process does not cause other parts of the system not to meet processing expectations, including but not limited to complying with SLAs.

In some examples, the cache usage is selected from the group consisting of: L2 eviction intensity, L3 eviction intensity, and L4 eviction intensity. This aspect improves the functionality of the computing system as a whole because while looking to dispatch work to an accelerator, the program code takes into account specific levels of resources utilized by other processes and hence, the decisions related to the work being dispatched are done in view of this granular understanding of the computing system.

In some examples, the hardware monitoring data is selected from the group consisting of: links usage, memory access, and cache usage. This aspect improves the functionality of the computing system because while looking to dispatch work to an accelerator, the program code considers specific aspects related to resources utilized by other processes and hence, the decisions related to the work being dispatched are done in view of this granular understanding of the computing system.

In some examples, the program code implements implementing the local hardware counters. This aspect improves the functionality of a system because the program code can make decisions with an understanding of the functionality of various components of the hardware infrastructure. Thus, although the program code makes a dispatch decision related to software, impacts on the hardware (and hence the whole of the system) can be considered.

In some examples, the program code obtaining the hardware monitoring data comprises: the program code obtaining system wide non-accelerator related real-time data from the local hardware counters. This aspect also improves the functionality of a system because the program code can make decisions with an understanding of the functionality of various components of the hardware infrastructure. Thus, although the program code makes a dispatch decision related to software, impacts on the hardware and hardware utilization (and hence the whole of the system) can be considered.

In some examples, the system wide non-accelerator related real-time data comprises cache eviction activity for each cache hierarchy level of caches comprising the computing system. This aspect provides a benefit to the computing system as a whole because of the speed and flexibility with which dispatch decisions can be made and implemented, improving load balancing.

In some examples, the system wide non-accelerator related real-time data comprises a processor cache footprint of each workload running in the computing system. This aspect provides a benefit to the computing system as a whole because of the speed and flexibility at a granular level with which dispatch decisions can be made and implemented, improving load balancing.

In some examples, the system wide non-accelerator related real-time data comprises bandwidth utilization between chip and to memory for each chip and each memory comprising the computing system. This aspect provides a benefit to the computing system as a whole because of the speed and flexibility at a granular level with which dispatch decisions can be made and implemented, improving load balancing.

In some examples, the given workload comprises an artificial intelligence (AI) process and the other workloads processing in the computing system concurrently with the given workload do not comprise AI processes. This aspect provides a benefit to the computing system because it balances the processing needs related to AI processes with those of non-AI processes, such that a certain process does not receive priority at the expense of another so that the specifications of the system, such as SLAs, can be met, while processing goals are achieved efficiently.

The examples herein can include a computer system for performance sensitive targeted accelerator dispatch. The computer system can include a memory and one or more processors in communication with the memory, where the computer system is configured to perform a method, said method. The method can include program code executing on the one or more processors initiating, from a first chip in a computing system, a request to utilize an accelerator in the computing system to process work associated with a given workload. The program code determines that a local accelerator on the first chip is not available to accept a dispatch of the work. The program code obtains hardware monitoring data from local hardware counters associated with various elements of the computing system. The program code determined, based on the hardware monitoring data, a best remote accelerator for dispatching the work to. The best remote accelerator comprises selecting an accelerator from one or more remote accelerators in the computing system, where based on the hardware monitoring data the selected accelerator utilizes bandwidth and one or more caches which are minimally accessed by other workloads processing in the computing system concurrently with the given workload when compared the other accelerators comprising the one or more remote accelerators. This example is inextricably tied to computing and provides a benefit to a computing system at least because it utilizes a combination of hardware and software to distribute processing to available accelerators in an optimal manner.

In some examples of the computer system, the program code determines if activity on a chip or core associated with best remote accelerator is below a pre-defined threshold. This example provides a benefit to the computing system because in existing approaches, processes, including AI processes, as distributed to accelerators capable of processing these types of processes without regard for the utilization of these resources by other processes being executed within the system. Thus, this aspect aids to ensure processing efficiencies throughout a computing system.

In some examples of the computer system, the program code, based on determining that the activity on the chip or the core associated with best remote accelerator is below the pre-defined threshold, dispatches the work to the best remote accelerator. Implementing this aspect improves the computing system at least because it enables the selection of a capable accelerator but also guards the processing efficiencies throughout the computing system as a whole.

In some examples of the computer system, the program code, based on determining that the activity on the chip or the core associated with best remote accelerator is not below the pre-defined threshold, queues the work for dispatch to the local accelerator. As aforementioned, the examples herein not only locate an accelerator for use for a given process, they examples also maintain the efficiencies throughout the system and in some situations, this translates to not dispatching work to a remote accelerator but rather, to wait until a local resource is available. This aspect benefits the system as a while because it balances the timing to improve a single process against the impacts to the computing system as a whole.

In some examples of the computer system, the program code determines that the local accelerator is available and dispatches the work to the local accelerator. This aspect provides a benefit because it balances the timing to improve a single process against the impacts to the computing system as a whole.

In some examples of the computer system, program code determining the best remote accelerator for dispatching the work to comprises program code ranking the one or more remote accelerators based on the hardware monitoring data. This aspect provides a benefit to computing systems into which it is implemented at least because the program code determines a best approach to dispatching a process to an accelerator and that the utility of the accelerator is not the only factor as a given accelerator that could handle work may not be a best accelerator to dispatch the work to because dispatching in this manner could adversely impact other work being accomplished by the computing system. Creating a ranking of accelerators accounts for the impacts and generates different levels of choices with a full understanding of overall computing system functionality and utility.

In some examples of the computer system, program code ranking comprises ranking the one or more remote accelerators by cache usage. This aspect improves the functionality of the computing system at least because it acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer system, program code ranking comprises ranking the one or more remote accelerators based on accelerator-unrelated activity on each chip or core comprising each remote accelerator of the one or more accelerators. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer system, program code ranking comprises evaluating link activity to reach each remote accelerator of the one or more remote accelerators from the first chip. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer system, the program code ranking comprises the program code evaluating potential cross-workload interference and impact to individual workload performance for workloads running on the computing system. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer system, the program code determines the cache usage of the one or more remote accelerators independent of accelerator availability. This aspect improves the functionality of the computing system and provides an advantage over existing approaches because in determining whether to dispatch a process to an accelerator, the program code is cognizant of other work being processed by the system as a whole, therefore optimizing a process does not cause other parts of the system not to meet processing expectations, including but not limited to complying with SLAs.

In some examples of the computer system, the cache usage is selected from the group consisting of: L2 eviction intensity, L3 eviction intensity, and L4 eviction intensity. This aspect improves the functionality of the computing system as a whole because while looking to dispatch work to an accelerator, the program code takes into account specific levels of resources utilized by other processes and hence, the decisions related to the work being dispatched are done in view of this granular understanding of the computing system.

In some examples of the computer system, the hardware monitoring data is selected from the group consisting of: links usage, memory access, and cache usage. This aspect improves the functionality of the computing system because while looking to dispatch work to an accelerator, the program code considers specific aspects related to resources utilized by other processes and hence, the decisions related to the work being dispatched are done in view of this granular understanding of the computing system.

In some examples of the computer system, the program code implements implementing the local hardware counters. This aspect improves the functionality of a system because the program code can make decisions with an understanding of the functionality of various components of the hardware infrastructure. Thus, although the program code makes a dispatch decision related to software, impacts on the hardware (and hence the whole of the system) can be considered.

In some examples of the computer system, the program code obtaining the hardware monitoring data comprises: the program code obtaining system wide non-accelerator related real-time data from the local hardware counters. This aspect also improves the functionality of a system because the program code can make decisions with an understanding of the functionality of various components of the hardware infrastructure. Thus, although the program code makes a dispatch decision related to software, impacts on the hardware and hardware utilization (and hence the whole of the system) can be considered.

In some examples of the computer system, the system wide non-accelerator related real-time data comprises cache eviction activity for each cache hierarchy level of caches comprising the computing system. This aspect provides a benefit to the computing system as a whole because of the speed and flexibility with which dispatch decisions can be made and implemented, improving load balancing.

In some examples of the computer system, the system wide non-accelerator related real-time data comprises a processor cache footprint of each workload running in the computing system. This aspect provides a benefit to the computing system as a whole because of the speed and flexibility at a granular level with which dispatch decisions can be made and implemented, improving load balancing.

In some examples of the computer system, the system wide non-accelerator related real-time data comprises bandwidth utilization between chip and to memory for each chip and each memory comprising the computing system. This aspect provides a benefit to the computing system as a whole because of the speed and flexibility at a granular level with which dispatch decisions can be made and implemented, improving load balancing.

In some examples of the computer system, the given workload comprises an artificial intelligence (AI) process and the other workloads processing in the computing system concurrently with the given workload do not comprise AI processes. This aspect provide a benefit to the computing system because it balances the processing needs related to AI processes with those of non-AI processes, such that a certain process does not receive priority at the expense of another so that the specifications of the system, such as SLAs, can be met, while processing goals are achieved efficiently.

The examples herein can include a computer program product for performance sensitive targeted accelerator dispatch. The computer program product can include one or more computer readable storage media and program instructions collectively stored on the one or more computer readable storage media readable by at least one processing circuit to perform a method. The method can include program code executing on the one or more processors initiating, from a first chip in a computing system, a request to utilize an accelerator in the computing system to process work associated with a given workload. The program code determines that a local accelerator on the first chip is not available to accept a dispatch of the work. The program code obtains hardware monitoring data from local hardware counters associated with various elements of the computing system. The program code determined, based on the hardware monitoring data, a best remote accelerator for dispatching the work to. The best remote accelerator comprises selecting an accelerator from one or more remote accelerators in the computing system, where based on the hardware monitoring data the selected accelerator utilizes bandwidth and one or more caches which are minimally accessed by other workloads processing in the computing system concurrently with the given workload when compared the other accelerators comprising the one or more remote accelerators. This example is inextricably tied to computing and provides a benefit to a computing system at least because it utilizes a combination of hardware and software to distribute processing to available accelerators in an optimal manner.

In some examples of the computer program product, the program code determines if activity on a chip or core associated with best remote accelerator is below a pre-defined threshold. This example provides a benefit to the computing system because in existing approaches, processes, including AI processes, as distributed to accelerators capable of processing these types of processes without regard for the utilization of these resources by other processes being executed within the system. Thus, this aspect aids to ensure processing efficiencies throughout a computing system.

In some examples of the computer program product, the program code, based on determining that the activity on the chip or the core associated with best remote accelerator is below the pre-defined threshold, dispatches the work to the best remote accelerator. Implementing this aspect improves the computing system at least because it enables the selection of a capable accelerator but also guards the processing efficiencies throughout the computing system as a whole.

In some examples of the computer program product, the program code, based on determining that the activity on the chip or the core associated with best remote accelerator is not below the pre-defined threshold, queues the work for dispatch to the local accelerator. As aforementioned, the examples herein not only locate an accelerator for use for a given process, they examples also maintain the efficiencies throughout the system and in some situations, this translates to not dispatching work to a remote accelerator but rather, to wait until a local resource is available. This aspect benefits the system as a while because it balances the timing to improve a single process against the impacts to the computing system as a whole.

In some examples of the computer program product, the program code determines that the local accelerator is available and dispatches the work to the local accelerator. This aspect provides a benefit because it balances the timing to improve a single process against the impacts to the computing system as a whole.

In some examples of the computer program product, program code determining the best remote accelerator for dispatching the work to comprises program code ranking the one or more remote accelerators based on the hardware monitoring data. This aspect provides a benefit to computing systems into which it is implemented at least because the program code determines a best approach to dispatching a process to an accelerator and that the utility of the accelerator is not the only factor as a given accelerator that could handle work may not be a best accelerator to dispatch the work to because dispatching in this manner could adversely impact other work being accomplished by the computing system. Creating a ranking of accelerators accounts for the impacts and generates different levels of choices with a full understanding of overall computing system functionality and utility.

In some examples of the computer program product, program code ranking comprises ranking the one or more remote accelerators by cache usage. This aspect improves the functionality of the computing system at least because it acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer program product, program code ranking comprises ranking the one or more remote accelerators based on accelerator-unrelated activity on each chip or core comprising each remote accelerator of the one or more accelerators. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer program product, program code ranking comprises evaluating link activity to reach each remote accelerator of the one or more remote accelerators from the first chip. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer program product, the program code ranking comprises the program code evaluating potential cross-workload interference and impact to individual workload performance for workloads running on the computing system. This aspect improves the functionality of the computing system at least because, like certain of the other aspects, it also acknowledges the linkages between different components in a computing system. In this case, although an accelerator may be available, the cache it would utilize could be engaged in other (unrelated) work. Thus, the program code aims to dispatch work to an accelerator that can do the work without compromising other processing.

In some examples of the computer program product, the program code determines the cache usage of the one or more remote accelerators independent of accelerator availability. This aspect improves the functionality of the computing system and provides an advantage over existing approaches because in determining whether to dispatch a process to an accelerator, the program code is cognizant of other work being processed by the system as a whole, therefore optimizing a process does not cause other parts of the system not to meet processing expectations, including but not limited to complying with SLAs.

In some examples of the computer program product, the cache usage is selected from the group consisting of: L2 eviction intensity, L3 eviction intensity, and L4 eviction intensity. This aspect improves the functionality of the computing system as a whole because while looking to dispatch work to an accelerator, the program code takes into account specific levels of resources utilized by other processes and hence, the decisions related to the work being dispatched are done in view of this granular understanding of the computing system.

In some examples of the computer program product, the hardware monitoring data is selected from the group consisting of: links usage, memory access, and cache usage. This aspect improves the functionality of the computing system because while looking to dispatch work to an accelerator, the program code considers specific aspects related to resources utilized by other processes and hence, the decisions related to the work being dispatched are done in view of this granular understanding of the computing system.

In some examples of the computer program product, the program code implements implementing the local hardware counters. This aspect improves the functionality of a system because the program code can make decisions with an understanding of the functionality of various components of the hardware infrastructure. Thus, although the program code makes a dispatch decision related to software, impacts on the hardware (and hence the whole of the system) can be considered.

In some examples of the computer program product, the program code obtaining the hardware monitoring data comprises: the program code obtaining system wide non-accelerator related real-time data from the local hardware counters. This aspect also improves the functionality of a system because the program code can make decisions with an understanding of the functionality of various components of the hardware infrastructure. Thus, although the program code makes a dispatch decision related to software, impacts on the hardware and hardware utilization (and hence the whole of the system) can be considered.

In some examples of the computer program product, the system wide non-accelerator related real-time data comprises cache eviction activity for each cache hierarchy level of caches comprising the computing system. This aspect provides a benefit to the computing system as a whole because of the speed and flexibility with which dispatch decisions can be made and implemented, improving load balancing.

In some examples of the computer program product, the system wide non-accelerator related real-time data comprises a processor cache footprint of each workload running in the computing system. This aspect provides a benefit to the computing system as a whole because of the speed and flexibility at a granular level with which dispatch decisions can be made and implemented, improving load balancing.

In some examples of the computer program product, the system wide non-accelerator related real-time data comprises bandwidth utilization between chip and to memory for each chip and each memory comprising the computing system. This aspect provides a benefit to the computing system as a whole because of the speed and flexibility at a granular level with which dispatch decisions can be made and implemented, improving load balancing.

In some examples of the computer program product, the given workload comprises an artificial intelligence (AI) process and the other workloads processing in the computing system concurrently with the given workload do not comprise AI processes. This aspect provides a benefit to the computing system because it balances the processing needs related to AI processes with those of non-AI processes, such that a certain process does not receive priority at the expense of another so that the specifications of the system, such as SLAs, can be met, while processing goals are achieved efficiently.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

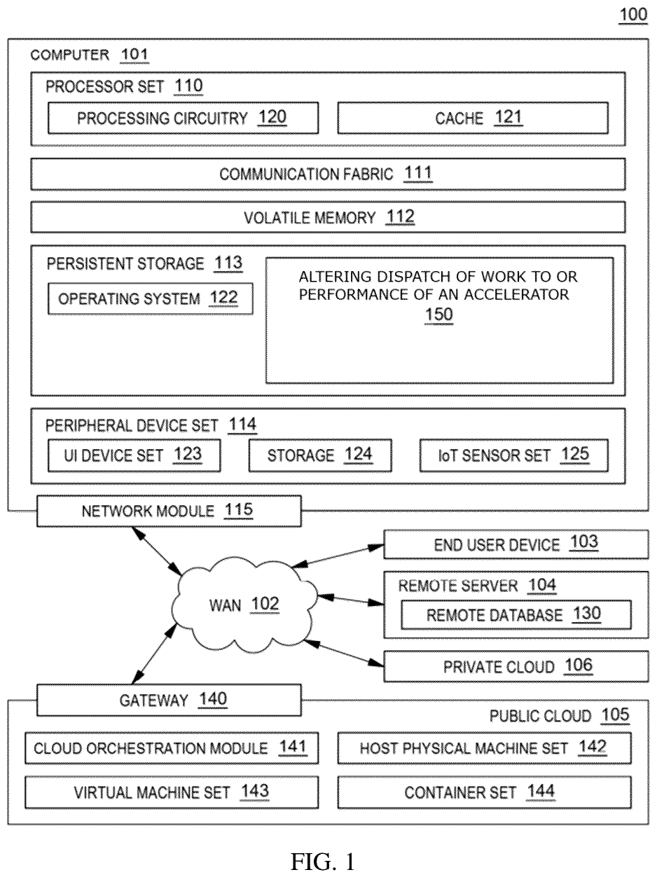

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code for proactively limiting or altering dispatch of work to or performance of an accelerator to achieve performance goals 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

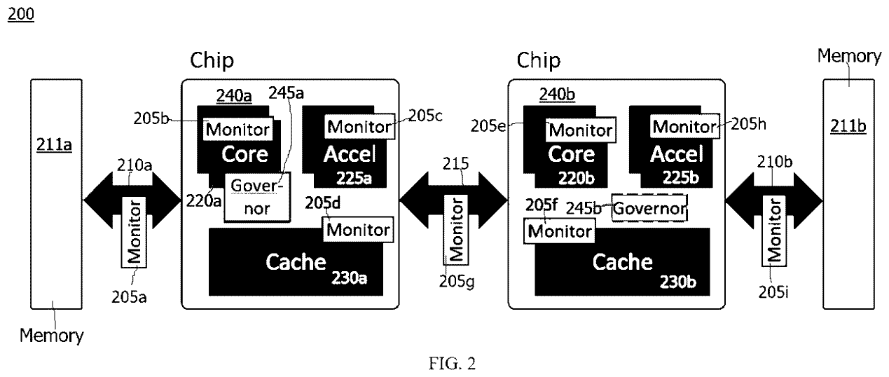

FIG. 2 illustrates a computing system 200 into which aspects of the examples herein can be implemented. In the examples herein, program code executing on one or more processors monitors activity within the computing system 200. The computer system 200 illustrated, which is provided as a non-limiting example, includes two chips 240a-240b and two memories 211a-211b. To monitor this activity, the program code interfaces with system wide hardware counters. Hence, monitoring hardware and/or software to hardware interfaces acts as monitors 205a-205i on various components of the computing system 200. In this computing system 200 (which is provided as a non-limiting example and for illustrative purposes only) monitors 205a-205i reside on memory interfaces 210a-210b, a chip-to-chip link 215, cores 220a-220b, accelerators 225a-225b, caches 230a-230b to monitor, among other things, cache activity and/or utilization of caches. The chips 240a-240b can also include a governor 245a-245b, or speed limiter or controller, which is a device used to measure and regulate the speed and/or issue rate of a machine and to control, for example, which accelerator is used to perform work (e.g., engine). In the examples herein, program code executing on one or more processors can utilize the monitors 205a-205i to monitor the utilization of system resources.

Based on the monitoring (which the program code accomplishes in real-time or near real-time), as will be discussed herein, the program code can throttle the accelerator 225a-225b usage, system dispatch characteristics for using the accelerators 225a-225b, and/or adjust elements of the system performance based on defined anticipated impact ranges. The monitors 205a-205i, which can be system-wide hardware counters, provide data (accounting), related to cache 230a-230b activity and/or utilization of caches 230a-230b, chip-to-chip links 215 and memory interfaces 210a-210b and the program utilizes the monitoring results to throttle and/or alter access (dispatch) of work to the accelerators 225a-225b and/or control the performance of the accelerators 225a-225b to balance computing system 200 resources or to reach and define performance targets for the various workloads. In addition to the proactive accelerator adjustments, the program code in the examples herein can also monitoring impacts on other workloads and throttle and/or steer accelerator 225a-225b usage based on this monitoring, albeit reactively.

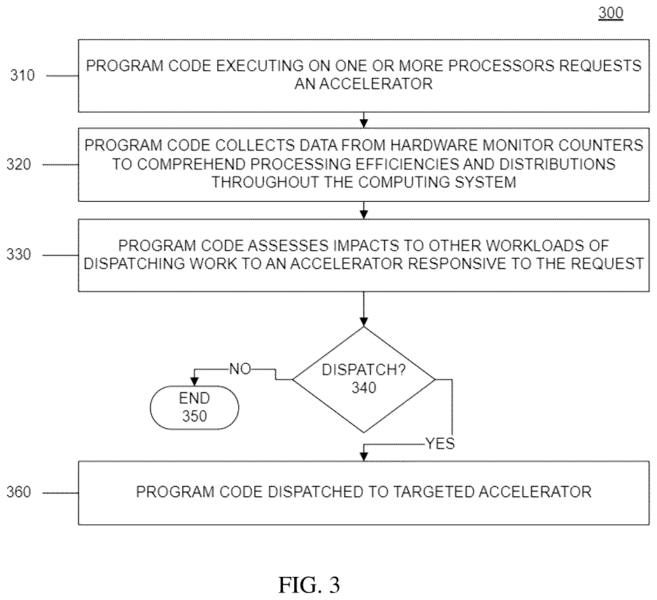

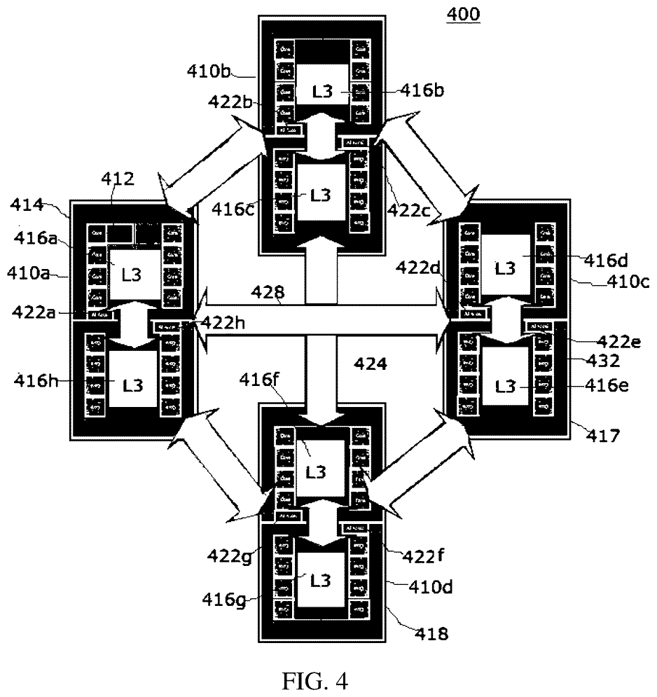

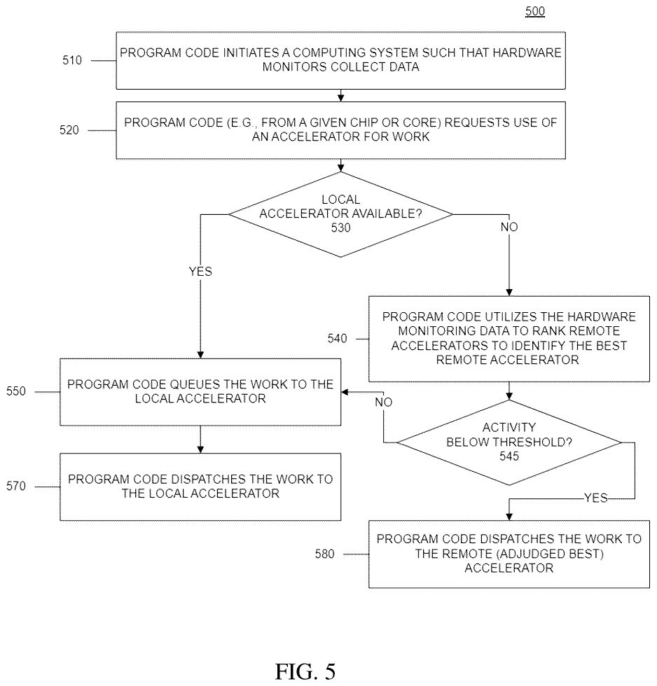

FIG. 3 is a general workflow 300 that is relevant to certain examples herein. Greater detail is offered in the workflow 500 of FIG. 5. As will be discussed herein, the program code in certain examples determines not only that dispatching work to an accelerator would be advantageous to certain processing while not detrimental to other processing (hence, advantageous to the computer system as a whole), but also which resources of the computing system should be utilized to implement the perceived improvement. While FIG. 3 provides a workflow 300 overview, FIG. 4 introduces aspects of a multi-cache computing system 400 to illustrate balancing considerations of the program code, and FIG. 5 provides additional details regarding this balancing in view of the complexities of distributed computing systems, including the computing system 400 of FIG. 4.

Referring to FIG. 3, the workflow 300 is executed by program code executing on one or more processors during runtime, hence, the computer system has started processing and program code that requests accelerators has also started. For case of understanding, this workflow 300 is depicted as linear but various processes can occur in parallel. Program code executing on one or more processors requests an accelerator (310). In these examples, a requestor chip can be a chip handling AI processing. During processing by the computing system, program code executing on one or more processors collects data from hardware monitor counters to comprehend processing efficiencies and distributions throughout the computing system (320). Based on the monitoring and obtaining the accelerator request, the program code assesses (potential) impacts to other workloads of dispatching work to an accelerator responsive to the request (330). As part of assessing, the program code determines both whether to dispatch work to an accelerator and to which accelerator the work should be dispatched to. Based on the assessment by the program code, the program code determines whether to dispatch work to an accelerator (340). The inquiry ends if the program code determines that work should not be dispatched to an accelerator (350). If the program code determines that work should be dispatched from a processor (e.g., chip, core), it dispatches work to a targeted accelerator (360). The request process terminates with this dispatch. In some examples, based on assessing (potential) impacts to other workloads of dispatching work (e.g., AI processing) to an accelerator responsive to the request, the program code also determines whether to throttle an accelerator in addition to determining whether to dispatch to an accelerator. In these examples, the program code, upon dispatch, can also set throttling.

As noted in FIG. 3, dispatching to (as well as throttling) an accelerator is a targeted activity. These examples depart from an automatic equitable distribution of processing or pre-planned accelerator utilization to units that are enabled to handle AI processing because to be reactive, in real-time, to processing efficiencies, specifications, guidelines, etc. Thus, as illustrated in FIG. 2, the program code monitors individual resources within a computing system 200 (e.g., that can handle AI processing) so that when the program code determines that an accelerator should be dispatched to and/or throttled, to assist with one or more of AI or non-AI workload processing, the program code also determines which resources and accelerators should be impacts (targeted). FIG. 4 is an illustration of a computing system 400 (a non-limiting example) which illustrates certain complexities in targeting accelerator activities.

FIG. 4 is a view of a computing system 400 where the computing system includes both physical and virtual caches. The computing system 400 includes dual chip modules (DCMs) 410a-410d. Each DCM of the DCMs 410a-410d contains two chips (e.g., silicon dies), each chip with 8 cores. The DCMs 410a-410d include caches of different levels. The four DCMs 410a-410d in this example (the chip modules), are interconnected. In general, central processing units (CPUs) can have a hierarchy of multiple cache levels (e.g., level 1 (L1), level 2 (L2), often level 3 (L3), and rarely level 4 (L4)), with different instruction-specific and data-specific caches at level 1. For case of understanding, the DCMs 410a-410d in the computing system 400 depicted in FIG. 4, include local caches (L2) and virtual caches (L3). An L1 cache is the fastest and smallest cache memory, located inside the CPU. Each core of a CPU has its own L1 cache. An L2 cache is located on a processor chip and has a higher capacity than an L1 cache but is slower. An L2 cache can be utilized to hold data that the CPU has recently used and is likely to be used again. An L3 cache has the largest capacity and is generally located outside the CPU and shared by all the CPU cores. One purpose of an L3 cache is to improve the performance of L1 and L2 caches. virtual cache).

In the computing system 400 of FIG. 4, virtual caches 416a-416h (L3 caches) enable a particular core, in this case a core of the first chip 414 (or the first chip 414 itself) of the first DCM 410a, to use part of the local (L2) caches of other cores on the same chip as victim caches. In general, a victim cache is a small and typically fully associative cache placed on a refill path of a central processing unit (CPU) and can be used to store all blocks evicted typically from L3 caches (as well as LA caches, but none is depicted in this non-limiting example).

Referring to FIG. 4, a first DCM 410a includes a chip 414 with a local cache 412 (an L2 cache) and a virtual cache 416a (an L3 cache). Each core in the DCMs 410a-410d can utilize virtual caches 416a-416h depending on utilization statistics for the L2 cache of each core of the DCMs 410a-410d. In this example, a given virtual cache 416a (an L3 cache) can be shared between all the cores (e.g., up to 8) of a chip 414 of the first DCM 410a (this is true of the other chips comprising the other DCMs 410b-410d, but this is provided as an example). Because virtual caches are shared, the operations or processing on a given chip can affect or impact resource usage on another chip because L3 virtual caches are used by more than one chip (e.g., there is overlapping use).

As discussed earlier, the program code can utilize resources within a computing system which are capable of processing AI operations to process AI operations. Not every resource in a computing system will necessarily have this capability. Additionally, when program code in the examples herein identify an AI (capable) unit to offload acceleration work to, the program code considers bandwidth (e.g., chip-to-chip bus utilization by other workloads along the path from core to reach a remote AI unit accelerator) and cache (e.g., the portion of the cache actively used on chip with the targeted remote AI unit accelerator). The latter is a consideration because if a given amount of the cache is already in use, offloading acceleration work to this AI unit could hinder processing of other workloads in the computing system. Each chip of each DCM 410a-410d in the computing system 400 of FIG. 4 comprises at least one accelerator 422a-422h.

Returning to FIG. 4, various workloads can be distributed by the program code to different cores of the DCMs 410a-410d. For example, a first workload can be distributed to 26 active cores, which can include the cores of the first DCM 410a, the cores of the second DCM 410b, and the cores of the third DCM 410c in the pictured computing system 400. This workload can utilize more than 1 GB of cache and hence utilizes some of the virtual L3 caches 416a-416e shared by the first chip 414 of the first DCM 410a, cores of the second DCM 410b, and cores of the third DCM 410c. Additionally, this first workload can utilize a unit capable of an AI workload, like the L3 cache 416a of the first chip 414, but in some cases, the cache of this chip 414 can already be utilized by a separate AI workload. Meanwhile, in this example, while the first workload is being processed as described, a second workload, which only utilizes seven cores and 400 MB of cache can be processed by a virtual L3 cache 416g accessible to cores of the fourth DCM 410d. From a client perspective, these workloads could have independent SLAs and would be unaware of each other's activity and that of the AI workload.

The allocation of the two workloads and the AI processing is as described above partially because this computing system 400 can include two independent Central Electronics Complex (CEC) or Central Processor Complex CPC internal partitions. This architecture can run, for example, on a z/OS system. This configuration is provided as a non-limited example as IBM's z/Architecture is one example of a technical architecture into which the examples herein can be implemented. z/Architecture, IBM, and z/OS are trademarks or registered trademarks of International Business Machines Corporation in at least one jurisdiction. A CEC provides a number of General Purpose (GP) processors and Specialty (SP) Processors. The hardware in a CEC can be managed by a hypervisor. CEC partitions and hardware partitions in different computing architectures can be co-located with an AI accelerator workload.

In the examples herein, program code executing on a given core can request AI acceleration. In this example, an AI workload was distributed to the first chip 414 of a first DCM 410a, specifically, and program code executing on this resource (e.g., one or more cores of a first chip 414 of the first DCM 410a) requests AI acceleration via a chip-to-chip bus 424 used. The program code of a core in the first chip 414 of the first DCM 410a utilizes the chip-to-chip bus to reach remote accelerators, and in this example, can utilize the chip-to-chip bus 424 to reach a remote accelerator 422e at the third DCM 410c. This remote accelerator 422e would utilize an L3 cache 416e on a remote chip 417. As aforementioned, to locate an AI unit (an appropriate accelerator to accelerate an AI workload), the program code of the requesting core (e.g., a core of the first chip 414 on the first DCM 410a) would consider bandwidth (chip-to-chip bus utilization by other workloads along the path (e.g., chip-to-chip bus 424) from the core (e.g., a core on a first chip 414 of the first DCM 410a) to reach the remote accelerator (e.g., remote accelerator 422c) and the cache (e.g., L3 cache 416e) actively used on a chip (e.g., a chip 417 of the third DCM 410c) with a targeted remote accelerator (e.g., remote accelerator 422e) to not hinder other workloads.

The program code of the core and/or chip requesting acceleration for an AI process can assess local hardware counters to evaluate whether to dispatch to or throttle acceleration. In this example, the program code can access a hardware counter 428 on the chip-to-chip bus 424 to determine bandwidth. The program code can access a hardware counter 432 on the remote chip 417 of the third DCM 410c to evaluate cache usage (e.g., 10×L2, vL3, Vl4 eviction rate HW).

Accounting for the workload distribution discussed above (provided as a non-limiting example), distributing two non-AI workloads and AI processing, program code in the examples herein can evaluate the computing system 400 to determine accelerator dispatch rankings. The program code can determine other workload aware accelerator dispatch rankings. In the examples herein, when program code obtains system wide non-accelerator related real-time hardware monitor data, the data can include cache eviction activity for each cache hierarchy level, bandwidth utilization between chip and to memory, and/or processor cache footprints of each workload running in a system. When the program code ranks accelerators in the system based on accelerator-unrelated activity on cores and/or chips containing the accelerators, the program code can also consider link activity to reach each potential target accelerator from an initiator chip and potential cross-workload interference and impact to individual workload performance. Hence, the program code can rank remote accelerators by L2, versus L3, and when relevant, versus LA eviction intensity (independent of accelerator availability) and collect hardware system monitor counters for links usage, memory access, as well as L2, versus L3, versus L4 eviction intensity.

As aforementioned, a core of a first chip 414 or the first chip 414 of the first DCM 410a requests acceleration for the AI processing. In this example, the best dispatch ranking for an accelerator would be the accelerator 422a, which is the accelerator that is local to the requestor, based on both bandwidth and cache. Logically, a local requestor, if available, would be preferable. A second-best ranking could be an accelerator 422f, an accelerator on the fourth DCM 410d, utilizing the associated cache (e.g., L3 cache 416f of a given chip 418 of the fourth DCM 410d) would be neutral relative to the computing system 400 and the bandwidth usage choice would be favorable. A third choice, with very unfavorable bandwidth as well as an unfavorable (less unfavorable than very unfavorable) cache would be an accelerator 422e on the third DCM 410c. Meanwhile, another accelerator 422d on the third DCM 410c can be utilized by the program code for normal load balancing for the first workload. Other accelerators 422h, 422b, 422c, 433g are all bad choices for the first workload for various reasons. Certain of these accelerators 422h, 422b are neutral as far as bandwidth but would stress the cache (e.g., very bad choices regarding associated caches), while some of these accelerators 422c, 422g would be very bad choices based both on bandwidth and cache impacts.

FIG. 5 is a workflow 500 that illustrates various aspects of some examples herein. Program code initiates a computing system such that hardware monitors collect data (510). The hardware monitors can include counters to collect data which include links usage, memory access, and cache usage information, including L2, versus L3, versus L4 eviction intensity. Program code (e.g., from a given chip or core) requests use of an accelerator for work (520). This work can be associated with an AI process that is being processed by resources local to the requestor. The program code determines if an accelerator local to the requestor is available (530). If the local accelerator is available, the program code queues the work to the local accelerator (550). The program code dispatches the work to the local accelerator (570). If the program code determines that the local accelerator is not available, the program code utilizes the hardware monitoring data to rank remote accelerators to identify the best remote accelerator (540). In some examples, the program code ranks the remote accelerators by cache usage, including but not limited to L2, versus L3, versus L4 eviction intensity, independent of accelerator availability. Having identified the best remote accelerator, the program code determines if activity on the chip and/or core with the best remote accelerator is below a (e.g., pre-defined) threshold (545). If the activity is not below the threshold, the program code queues the work to the local accelerator (550). The program code then dispatches the work to the local accelerator (570). If the activity is below the threshold, the program code dispatches the work to the remote (adjudged best) accelerator (580). Abiding by the activity threshold allows for the distribution of work to remote accelerators without adversely impacting other workloads.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. A computer-implemented method for performance sensitive targeted accelerator dispatch, comprising:
initiating, by one or more processors from a first chip in a computing system, a request to utilize an accelerator in the computing system to process work associated with a given workload;
determining, by the one or more processors, that a local accelerator on the first chip is not available to accept a dispatch of the work;
obtaining, by the one or more processors, hardware monitoring data from local hardware counters associated with various elements of the computing system; and
determining, based on the hardware monitoring data, a best remote accelerator for dispatching the work to, wherein the best remote accelerator comprises selecting an accelerator from one or more remote accelerators in the computing system, wherein based on the hardware monitoring data the selected accelerator utilizes bandwidth and one or more caches which are minimally accessed by other workloads processing in the computing system concurrently with the given workload when compared the other accelerators comprising the one or more remote accelerators.

2. The computer-implemented method of claim 1, further comprising:
determining, by the one or more processors, if activity on a chip or core associated with best remote accelerator is below a pre-defined threshold.

3. The computer-implemented method of claim 2, further comprising:
based on determining that the activity on the chip or the core associated with best remote accelerator is below the pre-defined threshold, dispatching the work to the best remote accelerator.

4. The computer-implemented method of claim 3, further comprising:
determining, by the one or more processors, that the local accelerator is available; and
dispatching, by the one or more processors, the work to the local accelerator.

5. The computer-implemented method of claim 1, wherein determining the best remote accelerator for dispatching the work to comprises ranking the one or more remote accelerators based on the hardware monitoring data.

6. The computer-implemented method of claim 5, wherein the ranking comprises ranking the one or more remote accelerators by cache usage.

7. The computer-implemented method of claim 5, wherein the ranking comprises ranking the one or more remote accelerators based on accelerator-unrelated activity on each chip or core comprising each remote accelerator of the one or more accelerators.

8. The computer-implemented method of claim 5, wherein the ranking comprises evaluating link activity to reach each remote accelerator of the one or more remote accelerators from the first chip.

9. The computer-implemented method of claim 5, wherein the ranking comprises evaluating potential cross-workload interference and impact to individual workload performance for workloads running on the computing system.

10. The computer-implemented method of claim 6, further comprising:
determining, by the one or more processors, the cache usage of the one or more remote accelerators independent of accelerator availability.

11. The computer-implemented method of claim 10, wherein the cache usage is selected from the group consisting of: L2 eviction intensity, L3 eviction intensity, and L4 eviction intensity.

12. The computer-implemented method of claim 1, wherein the hardware monitoring data is selected from the group consisting of: links usage, memory access, and cache usage.

13. The computer-implemented method of claim 1, further comprising:
implementing, by the one or more processors, the local hardware counters.

14. The computer-implemented method of claim 1, wherein obtaining the hardware monitoring data comprises:
obtaining, by the one or more processors, system wide non-accelerator related real-time data from the local hardware counters.

15. The computer-implemented method of claim 14, wherein the system wide non-accelerator related real-time data comprises cache eviction activity for each cache hierarchy level of caches comprising the computing system.

16. The computer-implemented method of claim 14, wherein the system wide non-accelerator related real-time data comprises a processor cache footprint of each workload running in the computing system.

17. The computer-implemented method of claim 14, wherein the system wide non-accelerator related real-time data comprises bandwidth utilization between chip and to memory for each chip and each memory comprising the computing system.

18. The computer-implemented method of claim 1, wherein the given workload comprises an artificial intelligence (AI) process and the other workloads processing in the computing system concurrently with the given workload do not comprise AI processes.

19. A computer system for performance sensitive targeted accelerator dispatch, comprising:
a memory; and
one or more processors in communication with the memory, wherein the computer system is configured to perform a method, said method comprising:
initiating, by the one or more processors from a first chip in a computing system, a request to utilize an accelerator in the computing system to process work associated with a given workload;
determining, by the one or more processors, that a local accelerator on the first chip is not available to accept a dispatch of the work;
obtaining, by the one or more processors, hardware monitoring data from local hardware counters associated with various elements of the computing system; and
determining, based on the hardware monitoring data, a best remote accelerator for dispatching the work to, wherein the best remote accelerator comprises selecting an accelerator from one or more remote accelerators in the computing system, wherein based on the hardware monitoring data the selected accelerator utilizes bandwidth and one or more caches which are minimally accessed by other workloads processing in the computing system concurrently with the given workload when compared the other accelerators comprising the one or more remote accelerators.

20. A computer program product for performance sensitive targeted accelerator dispatch, the computer program product comprising:
one or more computer readable storage media and program instructions collectively stored on the one or more computer readable storage media readable by at least one processing circuit to:
initiate, from a first chip in a computing system, a request to utilize an accelerator in the computing system to process work associated with a given workload;
determine that a local accelerator on the first chip is not available to accept a dispatch of the work;
obtain hardware monitoring data from local hardware counters associated with various elements of the computing system; and
determine, based on the hardware monitoring data, a best remote accelerator for dispatching the work to, wherein the best remote accelerator comprises selecting an accelerator from one or more remote accelerators in the computing system, wherein based on the hardware monitoring data the selected accelerator utilizes bandwidth and one or more caches which are minimally accessed by other workloads processing in the computing system concurrently with the given workload when compared the other accelerators comprising the one or more remote accelerators.
